(19) United States
(12) Patent Application Publication
(10) Pub. No.: US 2024/0352387 A1
(43) Pub. Date: Oct. 24, 2024

(54) METHOD OF MAKING TEQUILA

(71) Applicant: Camp Fire Smoked Spirits, LLC, Santa Monica, CA (US)

(72) Inventors: Jennifer Orme Erwin, Santa Monica, CA (US); Joel García Barreto, Guadalajara (MX)

(21) Appl. No.: 18/645,291

(22) Filed: Apr. 24, 2024

Related U.S. Application Data
(60) Provisional application No. 63/461,495, filed on Apr. 24, 2023.

(51) Int. Cl. C12G 3/02; C12G 3/07

(52) U.S. Cl. CPC C12G 3/02; C12G 3/07

(57) ABSTRACT

A method of making smoked colored tequila is disclosed.

### FIELD

This relates generally to a method of making tequila, and more particularly, to a method of making a smoked tequila with certain color and flavor.

### BACKGROUND

Tequila is a distilled beverage made from the blue agave plant or specifically, the Weber blue agave.

### BRIEF DESCRIPTION OF THE DRAWINGS

FIG. 1 illustrates the exemplary steps in a method of making a smoked colored tequila, according to an embodiment of the disclosure.

FIG. 2 illustrates the exemplary steps in a method of making a smoked colored tequila, according to another embodiment of the disclosure.

FIG. 3 illustrates the exemplary steps in a method of making a smoked colored tequila, according to another embodiment of the disclosure.

FIG. 4 illustrates the exemplary steps in a method of making a smoked colored tequila, according to another embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used, and structural changes can be made without departing from the scope of the embodiments of this disclosure.

One embodiment of this disclosure is related to a method of making a smoky and non-smoky flavored colored tequila.

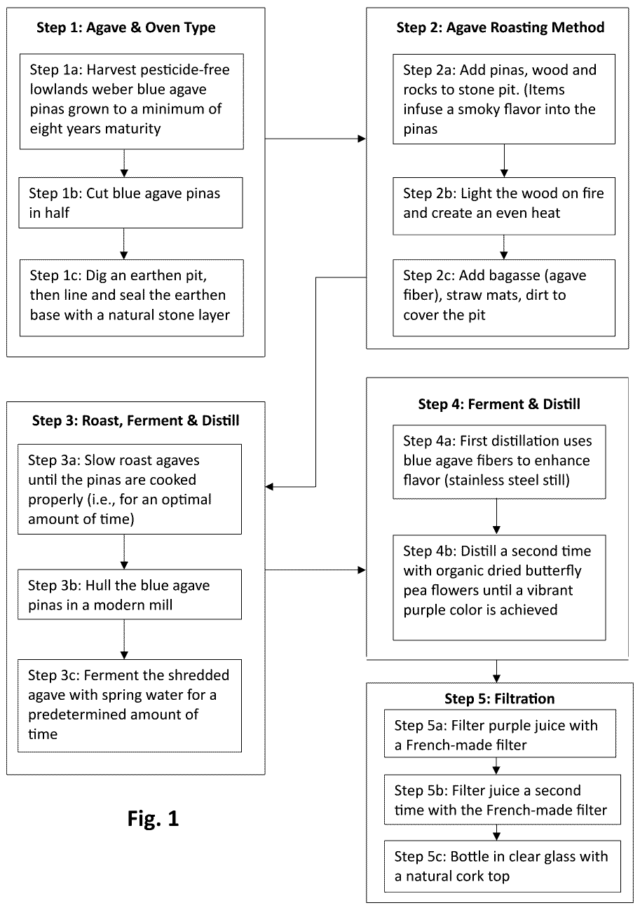

FIG. 1 is a flow chart illustrating the five exemplary main steps and numerous sub steps of each of these main steps of an embodiment of the disclosed method of making a smoked colored tequila.

As illustrated, the process starts with agave harvesting and preparing an oven for roasting agave pinas (step 1). First, pesticide-free lowlands Weber blue agave pinas grown to a minimum of eight years maturity are harvested (step 1a). This is different from conventional processes that use agave pinas harvested much earlier (typically at about four years maturity). Tequila made from agave pinas harvested at four years maturity leaves a bitter taste that needs to be covered up with additives like glycerin and sugar. Harvesting agave pinas with a minimum of eight years maturity eliminates the bitter taste, thereby eliminating the need for additives.

Once harvested, the Weber Blue Agave pinas are either left whole or cut in half (step 1b).

To prepare for roasting the agave, we dig an earthen pit, then line and seal the earthen base with a natural stone layer (step 1c). Doing so gives the tequila a smoky and vanilla flavor that no other type of oven used in roasting blue agave can achieve. Indeed, no other tequila is cooked in an earthen pit sealed entirely with a stone layer. In an alternative embodiment, a brick oven (or Horno) can be used instead of a stone Earthen pit oven to roast the blue agave pinas. All other steps in the process described herein remain the same. The tequila made by using a brick oven for roasting the blue agave pinas is a non-smoky colored tequila.

After the agave pinas are harvested and the earthen pit is ready, the agave pinas are roasted (step 2). Our roasting method involves first adding the agave pinas along with wood and rocks to our hand-made stone pit (step 2a). Wood and rocks assist in infusing a smoky flavor into the pinas. In some embodiments, the rocks added to the stone pit can be Mexican lava rocks. This is different from other known methods that use a brick oven or horno (steams the agave in 50-72 hours) or a diffuser (pressurized speed cooking for approximately 8-24 hours, stripping medicinal properties from the agave.). Both of these known methods are tailored for mass production, whereas our process is artisanal and crafted in smaller batches.

Next, the wood in the stone pit is light on fire to create an even heat (step 2b). The following sub-step is also not found in any existing tequila producing processes: Bagasse (agave fiber), natural straw mats, reclaimed wood to hold down the straw mats and dirt to fill in any micro-areas where smoke could escape are then added to cover the stone pit (step 2c). The majority of existing processes for mezcal use plastic tarps to cover the oven. In contrast, embodiments of the present disclosure do not use plastic in any part of the tequila-crafting process. Commonly, plastic drums are used to store the juice and we do not.

The next phase of the process comprises roasting, fermenting, and distilling (step 3). The agaves in the stone pit are slow roasted until the pinas are cooked properly (e.g., for a predetermined optimal amount of time that is longer than other conventional cooking methods, approximately 168 hours) (step 3a). The blue agave pinas are hulled in a modern mill (step 3b). The shredded agave is then fermented with spring water for a predetermined amount of time (step 3c).

Next, the agave is fermented and distilled again (step 4). Specifically, distillation using blue agave fibers is performed to enhance flavor (step 4a). This can be done using a stainless steel still. The product is the distilled again for a second time with organic dried butterfly pea flowers until a vibrant purple color is achieved (step 4b). In some embodiments, an extract of organic dried butterfly pea flowers, a powder of organic dried butterfly pea flowers, or any derivative of the butterfly pea flowers can be used in lieu of organic dried butterfly pea flowers in step 4b.

These two distillation steps can produce the desired flavor and color unique to our tequila. No other processes use the same distillation processes as described herein.

Finally, filtration is performed (step 5). In particular, the purple juice produced at the end of step 4 is filtered with a filter such as a rare French-made filter (step 5a), then a second time with the French-made filter (step 5b), and finally bottled in clear glass with a natural cork top (step 5c). In one embodiment, the twice-filtered juice is bottled right away to avoid flavor contamination and impurities by being held in a tank. In another embodiment (the reposado expression), the twice-filtered juice is matured in French oak cognac barrels, developing an aromatic bouquet of vanilla, elevated sweetness and hints of woodsmoke. The second embodiment also achieves the purple color from the butterfly pea flowers.

No other maker or recipe utilizes the exact method of producing tequila as described above. Moreover, no maker infuses artisan smoked blue agave blanco or reposado tequila with one additional botanical (i.e., the vitamin rich butterfly pea flowers). Indeed, in other embodiments of the present disclosure, butterfly pea flowers or extract of or any derivative of the butterfly pea flower, can be added to the agave juice (i.e., tequila or mezcal) made from traditional agave cooking and distillation methods.

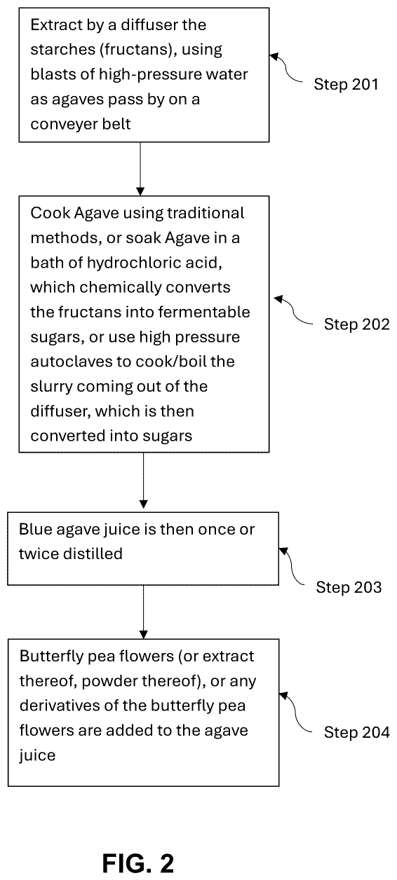

For example, in the embodiment illustrated in FIG. 2, instead of cooking the agave first, and then separating the sugars from the fibers, a diffuser can extract the starches (fructans) first, using blasts of high-pressure water as agaves pass by on a conveyer belt. (Step 201) The agaves can then either be cooked using traditional methods or soaked in a bath of hydrochloric acid, which chemically converts the fructans into fermentable sugars. Alternatively, in some embodiment, instead of using acid, some diffuser-made products can use high pressure autoclaves to cook/boil the slurry coming out of the diffuser, which is then converted into sugars. (Step 202) In some cases, heat, acid and high pressure are used simultaneously for the quickest results. Blue agave juice is then once or twice distilled. (Step 203) Finally, the butterfly pea flowers (or extract thereof, powder thereof), or any derivatives of the Butterfly Pea Flower are added to the agave juice, otherwise known as tequila or mezcal. (Step 204)

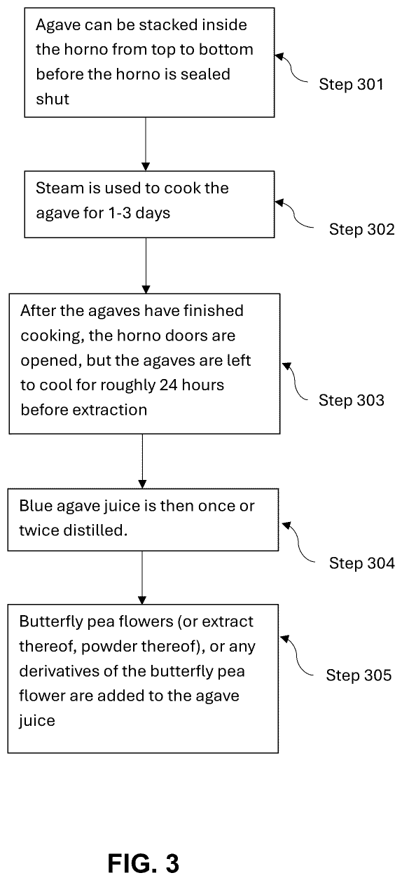

In another embodiment, as illustrated in FIG. 3, agave can be stacked inside the horno from top to bottom before the horno is sealed shut. (Step 301) Steam is used to cook the agave for 1-3 days. (Step 302) After the agaves have finished cooking, the horno doors are opened, but the agaves are left to cool for roughly 24 hours before extraction. (Step 303) Blue agave juice is then once or twice distilled. (Step 304) Finally, the Butterfly Pea Flowers (or extract thereof, powder thereof), or any derivatives of the Butterfly Pea Flower are added to the agave juice, otherwise known as tequila or mezcal. (Step 305)

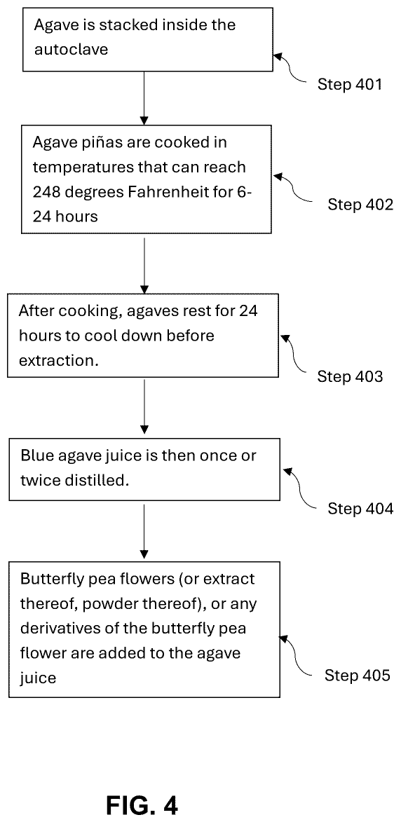

In yet another embodiment, as illustrated in FIG. 4, autoclaves are made from stainless steel and act as a large pressure cooker for cooking agaves. Agave is stacked inside the autoclave, similar to the horno. (Step 401) Agave piñas are cooked in temperatures that can reach 248 degrees Fahrenheit for 6-24 hours. (Step 402) After cooking, agaves rest for 24 hours to cool down before extraction. (Step 403) Along with a higher heat, autoclaves allow for a higher pressure, which provides a more constant and direct heat to the agave. This method is appealing because the autoclaves can work more efficiently than hornos, allowing agave to be cooked faster without compromising quality. Blue agave juice is then once or twice distilled. (Step 404) Finally, the butterfly pea flowers (or extract thereof, powder thereof), or any derivatives of the butterfly pea flower are added to the agave juice, otherwise known as tequila or mezcal. (Step 405)

Although blue agave is used in the embodiments described above, other agave varietals can be used for crafting other purple/Butterfly Pea Flower infused agave spirits (e.g., Sotol, Raicilla, Bacanora, Mezcal) using the same processes described above. These other agave varietals can include, but are not limited to, San Martin, Cenizo, Tobala, Del Maguey, Mexicano, Espadin, Maximiliana or Raicilla, Pacifica, Desert Spoon, Papalote, Tepextate, Papalometl or Cupreata, Karwinskii or any edible or consumable agave.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method of making tequila comprising:
harvesting weber blue agave pinas ground to a minimum of 8 years maturity;
preparing an earthen pit lined and sealed with a natural stone layer;
adding the blue agave pinas, wood and rocks to the earthen pit;
slow roasting the blue agave pinas for a first predetermined amount of time;
hulling the blue agave pinas in a modern mill;
fermenting the blue agave pinas with sprint water for a second predetermined amount of time to produce a fermented liquid;
performing a first distillation of the fermented liquid using blue agave fibers to enhance flavor;
performing a second distillation of the fermented liquid with an organic dried butterfly pea flower ingredient to produce a juice;
filtering the juice twice with a filter; and
bottling the filtered juice in clear glass with a natural cork top.

2. The method of claim 1, further comprising adding bagasse, straw mats, and dirt to cover the earthen pit when roasting the blue agave pinas.

3. The method of claim 1, wherein bottling the filtered juice is performed immediately after the filtering step without holding the filtered juice in a tank.

4. The method of claim 1, further comprising maturing the filtered juice in French oak Cognac barrels to develop an aromatic bouquet of vanilla and hints of woodsmoke prior to bottling the juice in glass.

5. The method of claim 1, wherein the second distillation of the fermented liquid is performed with no ingredient added other than the organic dried butterfly pea flowers.

6. The method of claim 1, wherein the juice produced after the second distillation is performed is purple.

7. The method of claim 1, wherein the organic dried butterfly pea flower ingredient comprises at least one of an organic dried butterfly pea flower, an extract of organic dried butterfly pea flower, a powder of organic dried butterfly pea flower, and a derivative of the butterfly pea flower.

8. A method of making tequila comprising:
extracting starches (fructans) from agaves by a diffuser;
processing the agaves to produce sugars;
extracting agave juice from processed agaves;
performing one or two distillations of the extracted agave juice to produce distilled agave juice; and
adding an organic dried butterfly pea flower ingredient to the distilled agave juice.

9. The method of claim 8 wherein extracting starches (fructans) by a diffuser comprises using blasts of high-pressure water on the agaves as the agaves pass by on a conveyer belt.

10. The method of claim 8, wherein processing the agaves to produce sugars comprises cooking the agaves.

11. The method of claim 8, wherein processing the agaves to produce sugars comprises soaking the agaves in a bath of hydrochloric acid to chemically convert the fructans into sugars.

12. The method of claim 8, wherein processing the agaves to produce sugars comprise using high pressure autoclaves to cook or boil slurry coming out of the diffuser and converting the cooked or boiled slurry into sugars.

13. The method of claim 8, wherein the organic dried butterfly pea flower ingredient comprises at least one of an organic dried butterfly pea flower, an extract of organic dried butterfly pea flower, a powder of organic dried butterfly pea flower, and a derivative of the butterfly pea flower.

14. A method of making tequila comprising:
stacking agaves inside a horno from top to bottom before sealing the horno shut;
cooking the agaves for 1-3 days using steam;
after finishing cooking the agaves, opening a door of the horno and leaving the agaves to cool in the horno before extraction;
extracting agave juice from the agaves;
performing one or two distillations of the extracted agave juice to produce distilled agave juice; and
adding an organic dried butterfly pea flower ingredient to the distilled agave juice.

15. The method of claim 14, wherein the organic dried butterfly pea flower ingredient comprises at least one of an organic dried butterfly pea flower, an extract of organic dried butterfly pea flower, a powder of organic dried butterfly pea flower, and a derivative of the butterfly pea flower.
